(19) United States
(12) Patent Application Publication
(10) Pub. No.: US 2020/0250503 A1
(43) Pub. Date: Aug. 6, 2020

(54) PASSIVE PHOTOELECTRIC TAG

(71) Applicant: ZTE CORPORATION, Shenzhen, Guangdong (CN)

(72) Inventors: Ying Wang, Shenzhen, Guangdong (CN); Jidong Xu, Shenzhen, Guangdong (CN); Min Yu, Shenzhen, Guangdong (CN); Luhong Mao, Shenzhen, Guangdong (CN)

(21) Appl. No.: 16/474,068

(22) PCT Filed: Nov. 27, 2017
(86) PCT No.: PCT/CN2017/113209

§ 371 Date: Jun. 27, 2019

(30) Foreign Application Priority Data
Dec. 27, 2016 (CN) 201611223329.X

(51) Int. Cl. G06K 19/07; G06K 7/10

(52) U.S. Cl. CPC G06K 19/0728; G06K 7/10009; G06K 19/0704

(57) ABSTRACT

The disclosure relates to the technology of optical communication, and specifically, to a passive photoelectric tag. The passive photoelectric tag includes: an photocell used to receive an optical signal; a service separation unit used to separate the received optical signal into a DC voltage and an AC signal; a transceiver unit used to perform photoelectric conversion and electric signal processing on an optical signal in the AC signal under power supply of the DC voltage to generate a signal to be transmitted; and an LED emission unit used to transmit the signal to be transmitted in a form of an optical signal. The passive photoelectric tag realizes power provision and signal receiving through a photocell, and power supply is not needed, the cost and the size of the passive photoelectric tag is reduced and the service life of the passive photoelectric tag is prolonged.

### CROSS-REFERENCE TO RELATED APPLICATIONS

This disclosure is based on and claims the priority of Chinese patent disclosure 201611223329.X, entitled “Passive Photoelectric Tag” and filed on Dec. 27, 2016, the entirety of which is incorporated herein by reference.

### FIELD OF THE INVENTION

The disclosure relates to the optical communication technology, and in particular, to a passive photoelectric tag.

### BACKGROUND OF THE INVENTION

With the development of the integrated circuit technology, passive tags based on the Radio Frequency Identification (RFID) technology have entered into a practical stage. The passive tags have advantages of being small in size, low in cost, non-contact, strong in anti-interference capability, long in service life and the like, and have been widely used in the fields of food, medical treatment, military, logistics and the like.

However, a common passive RFID tag needs a reader-writer with a large transmitting power to supply energy for the tag. Therefore, the common passive RFID tag has large electromagnetic radiation, and long-term use of the common passive RFID tag is harmful to the human body. In addition, considering effects of the electromagnetic radiation on health, only 1-2 RFID working frequency bands can be used for the common passive RFID tag, and most of the RFID working frequency bands cannot be used for the common passive RFID tag.

The Visible Light Communication (VLC) technology is an optical wireless communication technology developed recently. A Light Emitting Diode (LED) is used as a emitting electrode, and received by a photoelectric detector to convert into an electric signal. The electric signal is sent to a receiver for demodulation processing, and a processed signal is returned to a reader-writer in a form of an optical signal via an LED driving circuit. Compared with the radio frequency wireless communication technology, the visible light communication technology has advantages of being no pollution, free of electromagnetic radiation, high in accuracy, free of bandwidth limitation and the like. Therefore, the novel passive photoelectric tag formed by applying the optical communication technology to the passive tag has a wide disclosure prospect.

For all current photoelectric tags, an external power source is needed to provide required energy, which limits costs, a size, and a service life of the photoelectric tags.

### SUMMARY OF THE INVENTION

A passive photoelectric tag is provided according to the embodiments of the disclosure, so as to reduce the cost and the size of a photoelectric tag and to prolong the service life of the photoelectric tag.

According to a first aspect of the embodiments of the disclosure, a passive photoelectric tag is provided, and the passive photoelectric tag includes:

a photocell, configured to receive an optical signal;

a service separation unit, connected with the photocell, and configured to separate the optical signal received by the photocell into a DC voltage and an AC signal;

a transceiver unit, connected with the service separation unit, and configured to perform photoelectric conversion processing and electric signal processing on an optical signal in the AC signal under power supply of the DC voltage to generate a signal to be transmitted; and

an LED emission unit, connected with the transceiver unit, and configured to transmit the signal to be transmitted in a form of an optical signal.

In an implementation manner of the embodiments of the disclosure, the photocell includes a solar cell.

In an implementation manner of the embodiments of the disclosure, the solar cell includes:

a gallium arsenide solar cell of 10 mm×10 mm×2 mm; or a monocrystalline silicon solar cell of 30 mm×30 mm×5 mm.

In an implementation manner of the embodiments of the disclosure, the service separation unit specifically includes:

a first capacitor used to isolate a DC signal and extract an AC signal, and a low-pass filter connected in parallel with the first capacitor and used to extract a DC voltage.

In an implementation manner of the embodiments of the disclosure, the low-pass filter includes an inductor and a second capacitor, wherein

an end of the inductor is connected with the photocell, and another end of the inductor is connected with the second capacitor and the transceiver unit, another end of the second capacitor is grounded.

In an implementation manner of the embodiments of the disclosure, the second capacitor is a chip capacitor with the largest capacitance value.

In an implementation manner of embodiments of the disclosure, the transceiver unit specifically includes:

a power management module, connected with an output end of a DC voltage of the service separation unit, and configured to process a DC signal to obtain a stable voltage source and to provide a power supply voltage for other modules;

a receiver module, connected with an output end of an AC signal of the service separation unit, and configured to process the AC signal to obtain a digital signal;

a digital circuit module, connected with the receiver module, and configured to perform encoding and decoding processing and data control to the digital signal to generate a signal to be transmitted;

an oscillator module, connected with the digital circuit module, and configured to generate a clock oscillation signal; and

an LED driving circuit module, connected with the digital circuit module, and configured to convert the signal to be transmitted into an optical signal and to drive the LED emission unit to transmit the optical signal.

In an implementation manner of the embodiments of the disclosure, a distance between a wavelength of the LED emission unit and an LED wavelength of a visible light of a reader-writer is larger than a set value.

In an implementation manner of embodiments of the disclosure, the LED emission unit uses a visible light with a different wavelength from a wavelength of an LED of the reader-writer to transmit.

In an implementation manner of the embodiments of the disclosure, a peak value of an LED emission spectrum of the LED emission unit and a peak vale of reception spectrum sensitivity of a photoelectric detector (PD) in a reader-writer correspond to a same wavelength range.

The passive photoelectric tag provided according to the embodiments of the disclosure includes: a photocell, which is used to receive an optical signal; a service separation unit, which is used to separate the optical signal received by the photocell into a DC voltage and an AC signal; a transceiver unit, which is used to perform photoelectric conversion processing and electric signal processing on an optical signal in the AC signal under power supply of the DC voltage to generate a signal to be transmitted; and an LED emission unit, which is used to transmit the signal to be transmitted in a form of an optical signal. The passive photoelectric tag realizes power provision and signal receiving through a photocell, and power supply is not needed, the cost and the size of the passive photoelectric tag are reduced and the service life of the passive photoelectric tag is prolonged.

### BRIEF DESCRIPTION OF THE DRAWINGS

In order to illustrate technical solutions in embodiments of the disclosure or in existing technologies, a simple introduction is made to the accompanying drawings needed to be used in description of the embodiments or the existing technologies. Obviously, the accompanying drawings in the following description only refer to some embodiments of the disclosure. For those skilled in the art, under the premise that no creative work is involved, other drawings can also be obtained based on these accompanying drawings.

FIG. 1 schematically shows a structure of a passive photoelectric tag provided according to the embodiments of the disclosure;

FIG. 2 schematically shows a structure of a passive photoelectric tag provided according to a preferred embodiment of the embodiments of the disclosure;

FIG. 3 schematically shows a structure of a digital circuit module provided according to the embodiments of the disclosure; and

FIG. 4 shows a diagram of optical communication between a passive photoelectric tag and a reader-writer in the embodiments of the disclosure.

### DETAILED DESCRIPTION OF THE EMBODIMENTS

The technical solutions in embodiments of the disclosure will be explained clearly and completely with reference to the accompanying drawings in the embodiments of the disclosure. Obviously, the embodiments described are only some embodiments of the disclosure, rather than all of the embodiments of the disclosure. All other embodiments obtained by those skilled in the art based on the embodiments of the disclosure under the premise that no creative work is involved fall within the protection scope of the disclosure.

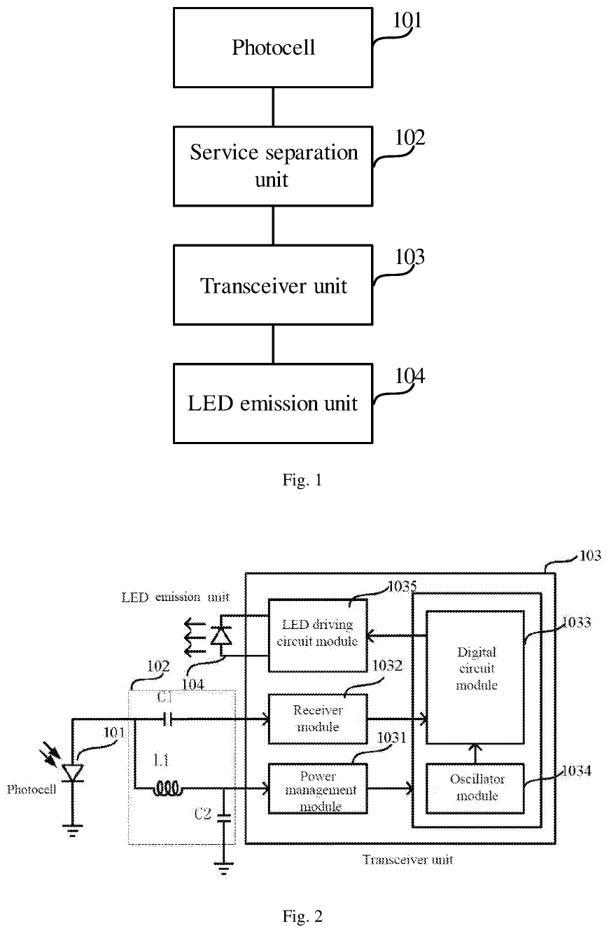

As shown in FIG. 1, a passive photoelectric tag provided by the embodiments of the disclosure includes:

a photocell 101, configured to receive an optical signal;

a service separation unit 102, connected with the photocell 101, and configured to separate the optical signal received by the photocell 101 into a DC voltage and an AC signal;

a transceiver unit 103, connected with the service separation unit 102, and configured to perform photoelectric conversion processing and electric signal processing on an optical signal in the AC signal under power supply of the DC voltage to generate a signal to be transmitted; and

an LED emission unit 104, connected with the transceiver unit 103, and configured to transmit the signal to be transmitted in a form of an optical signal.

The passive photoelectric tag realizes power provision and signal receiving through a photocell, and power supply is not needed, the cost and the size of the passive photoelectric tag is reduced and the service life of the passive photoelectric tag is prolonged.

An internal working manner of the passive photoelectric tag is as follows: the photocell 101 separates a received external visible light signal into two parts through the service separation unit 102. One part of the light is converted into electric energy required for working of the tag, and the converted electric energy provides energy for each unit; the other part of the light signal carrying a signal undergoes a photoelectric conversion processing through the transceiver unit 103, and after the processed electric signal undergoes a electric signal processing, a signal is loaded and transmitted through the LED emission unit 104.

By using the photocell to receive a visible light signal, effective reception and detection of a signal can be achieved by a light reception and detection capability of the photocell, and moreover the photocell can provide a power supply voltage for working of a photoelectric tag through conversion from optical energy to electrical energy, so as to form a non-contact novel passive photoelectric tag. Compared with existing photoelectric tags, the novel passive photoelectric tag is low in cost, small in size, and has a longer service life, and overcomes a disadvantage that the passive radio frequency tag is large in electromagnetic radiation and harmful to a human body.

In the embodiments of the disclosure, the photocell is adopted to replace a common photodiode to serve as a visible light detector. After being irradiated by an LED visible light signal, the photocell generates a constantly changing DC voltage which can be regarded as a superposition of a constant DC voltage and an AC voltage. The constant DC voltage can provide a power supply voltage required by a receiver through circuit processing, so as to obtain a novel passive photoelectric tag.

In practical disclosure, the photocell may include a solar cell. For example, a gallium arsenide solar cell of 10 mm×10 mm×2 mm or a monocrystalline silicon solar cell of 30 mm×30 mm×5 mm may be used.

In an implementation manner of the embodiments of the disclosure, as shown in FIG. 2, the service separation unit 102 specifically includes:

a first capacitor C1 used to isolate a DC signal and extract an AC signal, and a low-pass filter connected in parallel with the first capacitor C1 and used to extract a DC voltage.

In an implementation manner of the embodiments of the disclosure, the low-pass filter includes: an inductor L1 and a second capacitor C2, in which

an end of the inductor L1 is connected with the photocell 101, and another end thereof is connected with the second capacitor C2 and the transceiver unit 103, another end of the second capacitor C2 is grounded.

Specifically, the service separation unit 102 includes two branches. One branch is the first capacitor C1 which may isolate a DC signal and extract and send an AC signal to the transceiver 103 for processing. The other branch includes the low-pass filter formed by an LC. In the low-pass filter, a voltage at two ends of the second capacitor C2 is a DC voltage. The AC signal with a high frequency is blocked by the inductor L1, and has little effect on the voltage at two ends of the second capacitor C2. At last, the voltage at two ends of the second capacitor C2 is input into the transceiver unit 103 to provide power supply to the transceiver unit 103.

A chip capacitor having the largest capacitance value can be used as the second capacitor C2.

In an implementation manner of the embodiments of the disclosure, as shown in FIG. 2, the transceiver unit 103 specifically includes:

a power management module 1031, connected with an output end of a DC voltage of the service separation unit 102, and configured to process the DC signal to obtain a stable voltage source and to provide a power supply voltage for other modules;

a receiver module 1032, connected with an output end of an AC signal of the service separation unit 102, and configured to process the AC signal to obtain a digital signal;

a digital circuit module 1033, connected with the receiver module 1032, and configured to perform encoding and decoding processing and data control to the digital signal to generate a signal to be transmitted;

an oscillator module 1034, connected with the digital circuit module 1033, and configured to generate a clock oscillation signal; and

an LED driving circuit module 1035, connected with the digital circuit module 1033, and configured to convert the signal to be transmitted into an optical signal and to drive the LED emission unit 104 to transmit the optical signal.

In an implementation manner of the embodiments of the disclosure, the power management module 1031 includes a voltage regulator, the voltage regulator includes a band-gap reference, a start-up circuit, an error amplifier, and serves to process a received DC signal to obtain a stable voltage source and provides a power supply voltage to other modules. Power management, having good stability, high power supply rejection (PSR), good linear adjustment rate and load regulation rate, and a low temperature coefficient, can ensure stable working of the receiver. Since a passive structure is adopted, power consumption should be reduced in the meantime of meeting basic performance indices.

The receiver module 1032 mainly includes an equalization circuit, a limiting amplifier circuit, and a comparator circuit, and serves to perform limiting amplification to an input AC digital, and then a signal is processed by a comparator, a digital signal is extracted for a further process through a digital circuit. In the design, realization of low power consumption in a circuit should also be paid attention to.

The digital circuit module 1033 mainly includes a decoder unit, a digital baseband, a memory, and an encoder unit, and mainly serves to perform encoding and decoding processing and data control to the digital signal extracted from the receiver module and generates a signal to be transmitted back to a reader-writer. A digital circuit module based on a reasonable communication protocol may have a stronger anti-interference performance and a lower error rate.

The oscillator module 1034 serves to generate a clock oscillation signal for use in working of a digital circuit, and may use a ring oscillation structure or a relaxation oscillation structure. Stability of an oscillation frequency is a main parameter of the oscillator module. Oscillation frequency of a good oscillator is less affected by voltage, temperature, and the process, which can ensure precision of working of the digital circuit.

The LED driving circuit module 1035 adopts a signal transmitted back to the reader-writer from the digital circuit module to drive the LED emission unit 104 so as to realize normal working of the LED emission unit 104. Since the LED driving circuit module accounts for the largest proportion of overall power consumption, realization of low power consumption of the LED driving circuit module is the key to achieve overall low power consumption of a tag.

The LED emission unit 104 transmits a signal back to the reader-writer in the form of an optical signal to complete optical signal communication. In order to put an LED into a driving circuit for simulation, the LED needs to be modeled, and a spice model or a veriloga model of the LED is put into a circuit for simulation.

As a preferred embodiment, an external solar cell may be used as a photocell. The solar cell may effectively absorb visible light, and convert an optical signal into an electric signal so as to generate a changing DC voltage. A DC signal and an AC signal are separated via a passive circuit network of a service separation unit, and are respectively provided to a power management module and a receiver module, so as to achieve a function of receiving optical signals. The solar cell can be made of materials such as monocrystalline silicon, polycrystalline silicon, gallium arsenide, and so on. Considering the size, the cost, and efficiency of optical energy conversion comprehensively, and under the premise that the solar cell stably provides power supply to a receiver, a solar cell satisfying requirements may be selected eclectically, such as a gallium arsenide solar cell of 10 mm×10 mm×2 mm, a monocrystalline silicon solar cell of 30 mm×30 mm×5 mm, and the like. It should be specifically pointed out that the size of the solar cell accounts for the largest proportion of the size of an overall passive photoelectric tag and limits the size of a tag. Moreover, the size of the photocell and efficiency of optical energy conversion also limit the amount of energy that the photocell supplies to an internal circuit of the tag, and also affect a working distance of the overall photoelectric tag. Therefore, those skilled in the art can take multiple factors into account when selecting a photocell.

In the embodiment of the disclosure, as shown in FIG. 2, a service separation unit 102 serves to separate a changing voltage generated by the solar cell into a DC signal and an AC signal. Specific implementation is as follows: according to a data transmission rate required by visible light communication, a proper capacitor C1 is selected, so that an AC voltage signal may enter the receiver with little attenuation. L1 and C2 form a low-pass filter which serves to extract a DC voltage signal to supply a power management module. A larger value may be selected for an inductor L1 which has very large impedance when the frequency is higher, so that AC signals are blocked from two ends of the C2. A chip capacitor with a value larger than a set value may be selected for a capacitor C2. On one hand, effects of an AC signal can be reduced; and on the other hand, a large amount of charge can be stored, and it is ensured that a stable voltage may still be provided when a visible light signal changes due to sudden interference.

As shown in FIG. 2, the receiver module 1032 may adopt an optical receiver structure in traditional visible light communication so as to extract a digital signal from a weak electric signal to input the digital signal into a digital circuit module.

As shown in FIG. 2, a power management module 1031, a digital circuit module 1033, and an oscillator module 1034 may be designed according to circuit structures of corresponding modules in a traditional RFID passive tag so as to realize functions of corresponding modules.

As shown in FIG. 2, LED driving circuit module 1035 may adopt a simple series structure, and an LED may be driven by a signal that is transmitted by the digital circuit module back to a reader-writer. As a preferred example, since the LED itself has a larger junction capacitance, an LED electricity release loop may be added to an LED driving circuit so as to increase a working bandwidth of the circuit. In addition, considering that leakage interference should be minimized, as shown in FIG. 1, the distance between a wavelength of an LED and a LED wavelength of a visible light of the reader-writer should be long enough to achieve wavelength division isolation. As a preferred example, a visible light may be selected for the LED of the reader-writer to transmit, and a light with different wavelength from a wavelength of the LED of the reader-writer may be selected for an LED in a photoelectric tag to transmit.

In an implementation manner of the embodiments of the disclosure, a distance between a wavelength of the LED emission unit and an LED wavelength of a visible light of the reader-writer may be larger than a set value. The LED emission unit can use a visible light with a different wavelength from a wavelength of the LED of the reader-writer to transmit.

A structure of the digital circuit module 1033 is schematically shown in FIG. 3, and the digital circuit module 1033 mainly includes an encoder, a decoder, a digital baseband circuit, and a memory. A digital signal extracted from the receiver enters the decoder for decoding. A decoded signal is processed by the digital baseband circuit, and carrying out data communication with the memory. In this way, a digital signal that needs to be transmitted back to the reader-writer is obtained. The digital signal that needs to be transmitted back is encoded by the encoder, and an obtained signal is converted by the LED driving circuit into an optical signal which is transmitted back to the reader-writer.

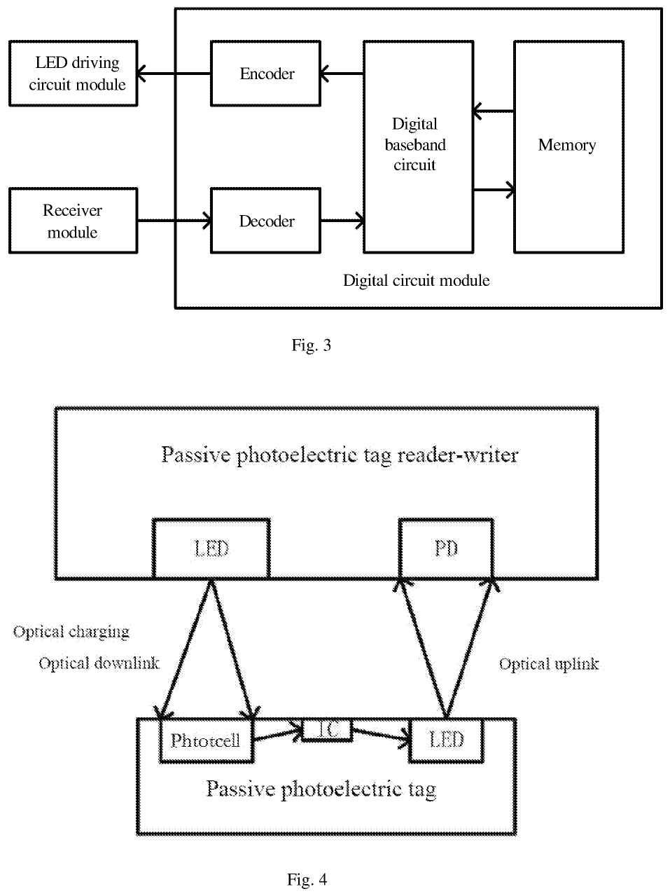

Besides, optical communication between a passive photoelectric tag and a reader-writer is shown in FIG. 4. After an LED of the reader-writer emits visible light carrying information, a photocell in the tag, on one hand, is being charged and converts an optical signal carrying information into an electric signal on the other hand. When charging energy meets requirements for power consumption of an internal circuit of the tag, the circuit works normally. A digital signal is extracted and processed, and returned data is converted into an optical signal carrying information via an LED and a driving circuit thereof. The returned optical signal is received by a photoelectric detector (PD) of the reader-writer for further processing. As can be seen, if a peak value of an LED emission spectrum in the passive photoelectric tag and a peak value of reception spectrum sensitivity of the PD in the reader-writer correspond to a same wavelength range, it means that energy utilization rate is improved, which is beneficial for reducing power consumption of an LED driving circuit. Overall power consumption of the photoelectric tag may be reduced accordingly.

By using a photocell to receive a visible light signal, the light reception and detection capability of the photocell realizes effective signal reception and detection, and moreover the photocell can provide a power supply voltage for working of a photoelectric tag through conversion from optical energy to electrical energy, so as to form a non-contact novel passive photoelectric tag. Compared with existing photoelectric tags, the novel passive photoelectric tag is low in cost, small in size, and has a longer service life, and overcomes a disadvantage that the passive radio frequency tag is large in electromagnetic radiation and is harmful to a human body.

Various embodiments in the description are described in a progressive manner, and reference can be made to other embodiments for the same or similar parts between various embodiments, and the description of each embodiment focuses on its difference from other embodiments. In particular, the description of a device embodiment is relatively simple since the device embodiment is basically similar to a method embodiment, and reference can be made to related description of the method embodiment.

Although the disclosure is described by way of embodiments, it is known to those skilled in art that many variations and modifications can be made to the disclosure without departing from the spirit and scope of the disclosure. Therefore, if these modifications and variations fall within the scope of claims of the disclosure and equivalent technologies thereof, it is intended that these modifications and variations are also covered in the disclosure.

### INDUSTRIAL APPLICABILITY

The passive photoelectric tag provided according to the embodiments of the disclosure includes: a photocell used to receive an optical signal; a service separation unit used to separate the optical signal received by the photocell into a DC voltage and an AC signal; a transceiver unit used to perform photoelectric conversion processing and electric signal processing on an optical signal in the AC signal under power supply of the DC voltage to generate a signal to be transmitted; and an LED emission unit used to transmit the signal to be transmitted in a form of an optical signal,. The passive photoelectric tag realizes power provision and signal receiving through a photocell, and power supply is not needed, the cost and the size of the passive photoelectric tag is reduced and the service life of the passive photoelectric tag is prolonged.

1. A passive photoelectric tag, comprising:
a photocell, configured to receive an optical signal;
a service separation unit, connected with the photocell, and configured to separate the optical signal received by the photocell into a DC voltage and an AC signal;
a transceiver unit, connected with the service separation unit, and configured to perform photoelectric conversion processing and electric signal processing on an optical signal in the AC signal under power supply of the DC voltage to generate a signal to be transmitted; and
an LED emission unit, connected with the transceiver unit, and configured to transmit the signal to be transmitted in a form of an optical signal.

2. The passive photoelectric tag according to claim 1, wherein the photocell comprises a solar cell.

3. The passive photoelectric tag according to claim 2, wherein the solar cell comprises:
a gallium arsenide solar cell of 10 mm×10 mm×2 mm; or
a monocrystalline silicon solar cell of 30 mm×30 mm×5 mm.

4. The passive photoelectric tag according to claim 1, wherein the service separation unit specifically comprises:
a first capacitor, used to isolate a DC signal and extract an AC signal, and a low-pass filter connected in parallel with the first capacitor and used to extract a DC voltage.

5. The passive photoelectric tag according to claim 4, wherein the low-pass filter comprises: an inductor and a second capacitor, wherein
an end of the inductor is connected with the photocell, and another end of the inductor is connected with the second capacitor and the transceiver unit, another end of the second capacitor is grounded.

6. The passive photoelectric tag according to claim 5, wherein the second capacitor is a chip capacitor with the largest capacitance value.

7. The passive photoelectric tag according to claim 1, wherein the transceiver unit specifically comprises:
a power management module, connected with an output end of a DC voltage of the service separation unit, and configured to process a DC signal to obtain a stable voltage source and to provide a power supply voltage for other modules;
a receiver module, connected with an output end of an AC signal of the service separation unit, and configured to process the AC signal to obtain a digital signal;
a digital circuit module, connected with the receiver module, and configured to perform encoding and decoding processing and data control to the digital signal to generate a signal to be transmitted;
an oscillator module, connected with the digital circuit module, and configured to generate a clock oscillation signal; and
an LED driving circuit module, connected with the digital circuit module, and configured to convert the signal to be transmitted into an optical signal and to drive the LED emission unit to transmit the optical signal.

8. The passive photoelectric tag according to claim 1, wherein a distance between a wavelength of the LED emission unit and an LED wavelength of a visible light of a reader-writer is larger than a set value.

9. The passive photoelectric tag according to claim 8, wherein the LED emission unit uses a visible light with a different wavelength from a wavelength of an LED of the reader-writer to transmit.

10. The passive photoelectric tag according to claim 1, wherein a peak value of an LED emission spectrum of the LED emission unit and a peak vale of reception spectrum sensitivity of a photoelectric detector (PD) in a reader-writer correspond to a same wavelength range.
